(19) United States
(12) Patent Application Publication
(10) Pub. No.: US 2015/0215199 A1
(43) Pub. Date: Jul. 30, 2015

(54) NETWORK DEVICE AND COMPUTER-READABLE RECORDING MEDIUM

(71) Applicant: FUJITSU LIMITED, Kawasaki-shi (JP)

(72) Inventors: Kenji Yamada, Onojou (JP); Yuichi Inao, Fukuoka (JP); Tatsuya Soneda, Fukuoka (JP)

(21) Appl. No.: 14/685,282

(22) Filed: Apr. 13, 2015

Related U.S. Application Data
(63) Continuation of application No. PCT/JP2012/078754, filed on Nov. 6, 2012.

(51) Int. Cl. H04L 12/721; H04L 12/18; H04L 29/08; H04W 40/24

(52) U.S. Cl. CPC H04L 45/26; H04W 40/246; H04L 12/1886; H04L 67/12; H04W 84/18

(57) ABSTRACT

If destination information on a packet is not present in a routing table, a network device broadcasts, to adjacent nodes, a path request packet in which destination information on a packet is set. When the network device receives a path response packet associated with the path request packet from another node, the network device sends the packet after setting a send source node of the path response packet to the transfer destination. Furthermore, if the network device does not receive the path response packet, the network device sends, by using flooding, a packet in which the destination information on the packet is set.

### CROSS-REFERENCE TO RELATED APPLICATION

This application is a continuation of International Application No. PCT/JP2012/078754, filed on Nov. 6, 2012, the entire contents of which are incorporated herein by reference.

### FIELD

The embodiments discussed herein are related to a network device and the like.

### BACKGROUND

In ad hoc networks, there is a technology that constructs path information by sequentially transmitting information on a routing table included in each node by using a Hello packet. This technology is based on a proactive-type path construction method. In a description below, a routing table is appropriately referred to as an RT.

For example, with the proactive-type path construction method, if hardware resources are insufficient, an amount of RT information is reduced by using some method. For example, the path construction is performed such that, in the uplink direction to a gateway (GW), the proactive-type path construction method is used and, in the downlink direction, a packet is transmitted through the path in inverse order of the uplink direction.

In contrast, as a path construction method that prohibits RT information from being transmitted, there is a reactive-type path construction method that creates paths before communication. With the reactive-type path construction method, a path request (RREQ) is subjected to flooding before communication and is sent to the destination as a notification, whereas the destination node that has received the RREQ sends a path response (RREP) to the send source node of the RREQ.

For example, the node that has received the RREQ can register, in an associated manner in an RT, the information on the send source node of the RREQ and the transfer source node of the RREQ. Consequently, the node that has received the RREQ can transfer the RREP to the send source of the RREQ. With the reactive-type path construction method, flooding is performed when communication is started. These related-art examples are described, for example, in Patent Document 1: International Publication Pamphlet No. WO 2009/130918.

However, with the conventional technology described above, there is a problem in that the communication band of an ad hoc network is compressed due to transmission of data packets performed by using flooding.

With the reactive-type path construction method, because flooding is performed when communication is started, the communication band is compressed.

Furthermore, with the proactive-type path construction method, if destination information on a packet is not present in an RT, flooding is performed by creating a broadcast packet in which the subject destination information is set, resulting in the communication band being compressed.

FIGS. 27, 28, and 29 are schematic diagrams each illustrating a problem of a conventional technology. As illustrated in FIG. 27, this ad hoc network includes a server 60, a GW 70, and nodes 10A to 10Z. The nodes 10A to 10Z are collectively and appropriately be referred to as nodes 10. The server 60 and the GW 70 are connected with each other via a network 50. The nodes 10 are connected to adjacent nodes with each other by using wireless communication. The GW 70 is connected to the adjacent nodes with each other by using the wireless communication. For example, the GW 70 is connected to the nodes 10A, 10B, 10C, 10D, and 10E with each other. For example, it is assumed that the nodes 10A, 10B, 10C, 10D, 10E, 10F, 10G, 10H, 10L, 10O are registered in the destination in the RT stored in the GW 70.

The GW 70 receives a packet from the server 60 and transfers, if the destination of the packet is registered in the RT, the packet on the basis of the RT. For example, if the destination of the packet is the node 10O, as illustrated in FIG. 28, the GW 10 transfers the packet to the node 10B. For example, the packet that has been transferred to the node 10B is transferred to the node 10O via the node 10G.

In contrast, the GW 70 receives a packet from the server 60 and performs, if the destination of the packet is not registered in the RT, data transmission by using flooding. For example, if the destination of a packet is the node 10M, as illustrated in FIG. 29, data transmission is performed by using the flooding. Namely, the GW 70 sets the destination to the node 10M, creates a packet for broadcast, and broadcasts the packet. Each of the nodes 10 that have received the broadcast packet broadcasts the packet again. Because each of the nodes 10 independently broadcasts the packet, the packet is delivered to the node 10M.

As described above, with the proactive-type path construction method, if destination information on a packet is not present in an RT and if the flooding illustrated in FIG. 29 occurs, the communication band is compressed.

### SUMMARY

According to an aspect of an embodiment, a network device includes a memory; and a processor coupled to the memory, wherein the processor executes a process including: broadcasting a path request packet in which a destination information on a first packet is set, to adjacent nodes, when the destination information on the first packet is not present in a routing table that is stored in the memory and in which destination information on other nodes included in an ad hoc network is set; sending a second packet by setting a send source node of a path response packet to the transfer destination of the second packet, when the path response packet associated with the path request packet is received from one of the other nodes; and flooding a third packet in which the destination information on the first packet is set, when the path response packet is not received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of a network device according to a first embodiment;

FIG. 2 is a schematic diagram illustrating the configuration of an ad hoc network according to a second embodiment;

FIG. 3 is a schematic diagram illustrating an example of the data structure of an adjacent RREQ packet according to the second embodiment;

FIG. 4 is a schematic diagram illustrating an example of the data structure of an adjacent RREP packet according to the second embodiment;

FIG. 5 is a schematic diagram illustrating an example of the data structure of a data packet according to the second embodiment;

FIG. 6 is a schematic diagram illustrating an example of the data structure of a hello packet according to the second embodiment;

FIG. 7 is a schematic diagram (No. 1) illustrating an example of a processing sequence of a data packet;

FIG. 8 is a schematic diagram (No. 2) illustrating an example of a processing sequence of a data packet;

FIG. 9 is a schematic diagram illustrating an example of a processing sequence of path construction in the uplink direction to a GW;

FIG. 10 is a schematic diagram illustrating an example of an RT created at the time of path construction of the uplink direction to the GW;

FIG. 11 is a schematic diagram illustrating an example of a processing sequence of path construction in the downlink direction;

FIG. 12 is a schematic diagram illustrating an example of an RT created at the time of path construction of the downlink direction;

FIG. 13 is a schematic diagram illustrating an example of a transmission path of a data packet when path construction in the downlink direction is performed;

FIG. 14 is a functional block diagram illustrating the configuration of a GW according to the second embodiment;

FIG. 15 is a flowchart illustrating the flow of a process performed by a branch processing unit;

FIG. 16 is a schematic diagram illustrating an example of the data structure of a link table;

FIG. 17 is a schematic diagram illustrating an example of the data structure of a routing table;

FIG. 18 is a schematic diagram illustrating an example of the data structure of an FID management table;

FIG. 19 is a flowchart (No. 1) illustrating the flow of a process performed by a data packet processing unit;

FIG. 20 is a flowchart (No. 2) illustrating the flow of a process performed by the data packet processing unit;

FIG. 21 is a flowchart illustrating an example of the flow of a timer process;

FIG. 22 is a flowchart illustrating the flow of a process performed by an adjacent packet processing unit;

FIG. 23 is a flowchart (No. 1) illustrating the flow of a path determination process performed by using an adjacent RREP;

FIG. 24 is a flowchart (No. 2) illustrating the flow of a path determination process performed by using the adjacent RREP;

FIG. 25 is a schematic diagram illustrating another embodiment;

FIG. 26 is a block diagram illustrating an example of a computer that executes a transmission program;

FIG. 27 is a schematic diagram illustrating a problem of a conventional technology;

FIG. 28 is a schematic diagram illustrating a problem of a conventional technology; and

FIG. 29 is a schematic diagram illustrating a problem of a conventional technology.

### DESCRIPTION OF EMBODIMENTS

Preferred Embodiments of the Present Invention will be explained with reference to accompanying drawings. The present invention is not limited to these embodiments.

### [a] First Embodiment

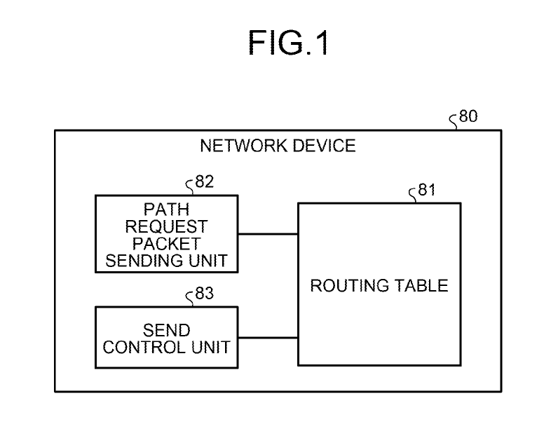

The configuration of a system according to the first embodiment will be described. FIG. 1 is a functional block diagram illustrating the configuration of a network device according to a first embodiment. As illustrated in FIG. 1, a network device 80 includes a routing table 81, a path request packet sending unit 82, and a send control unit 83.

The routing table 81 is information in which destination information on the other nodes included in an ad hoc network is set.

The path request packet sending unit 82 is a processing unit that broadcasts, to adjacent nodes if destination information on a packet is not present in the routing table 81, a path request packet in which the destination information on the packet is set.

When the send control unit 83 receives a path response packet associated with the path request packet from another node, the send control unit 83 sets the send source node of the path response packet to the transfer destination and sends the packet. If the send control unit 83 does not receive a path response packet, the send control unit 83 sends, by using flooding, a packet in which the destination information on the packet is set.

An advantage of the network device 80 according to the first embodiment will be described. If destination information on a packet is not present in the routing table 81, the network device 80 broadcasts, to adjacent nodes, a path request packet in which the destination information on the packet is set. If the network device 80 receives a path response packet associated with the path request packet from another node, the network device 80 sets the send source node of the path response packet to the transfer destination and sends the packet. Furthermore, if the network device 80 does not receive a path response packet, the network device 80 sends, by using flooding, a packet in which the destination information on the packet is set.

Consequently, it is possible to reduce the flooding rate performed when destination information on a packet is not present in the routing table 81 and thus it is possible to prevent the communication band of an ad hoc network from being compressed.

### [b] Second Embodiment

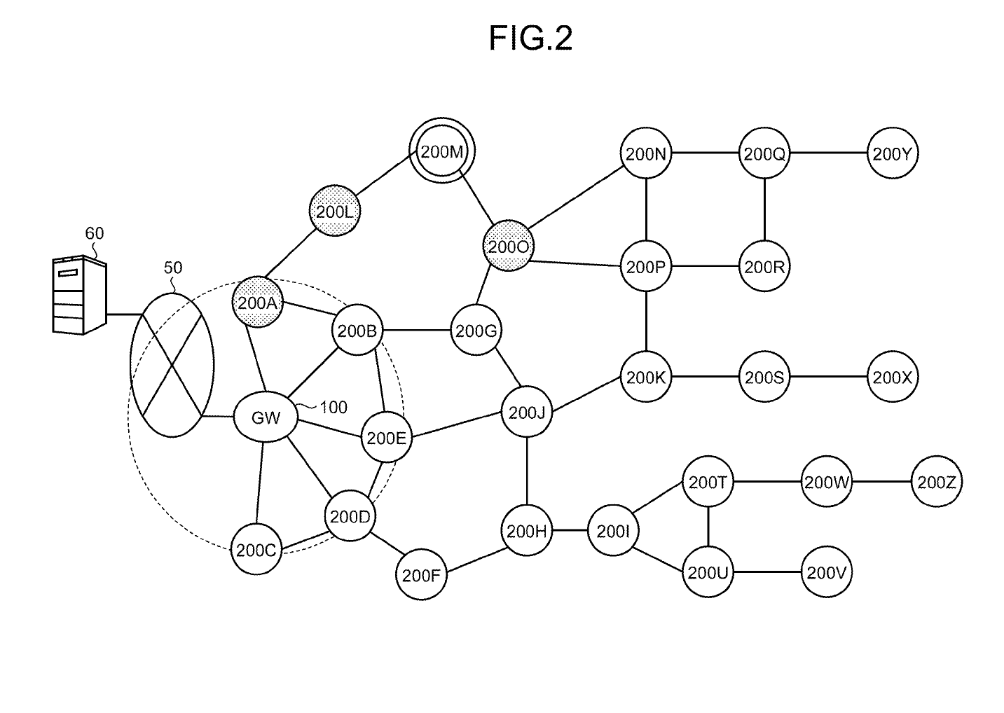

An ad hoc network according to a second embodiment will be described. FIG. 2 is a schematic diagram illustrating the configuration of an ad hoc network according to a second embodiment. As illustrated in FIG. 2, the ad hoc network includes the server 60, a GW 100, and nodes 200A to 200Z. The node 200A to the node 200Z are collectively and appropriately referred to as nodes 200.

The server 60 and the GW 100 are connected with each other via the network 50. The GW 100 is connected to the adjacent nodes with each other by using wireless communication. For example, the GW 100 is connected to the nodes 200A, 200B, 200C, 200D, and 300E with each other. For example, it is assumed that the nodes 10A, 10B, 10C, 10D, 10E, 10F, 10G, 10H, 10L, and 10O are registered in the destination of the GW 100 in the routing table. In a description below, the routing table is appropriately be referred to as an RT.

Each of the GW 100 and the nodes 200A to 200Z is an example of a network device.

The GW 100 receives a packet from the server 60 and broadcasts, to the adjacent nodes if destination information on the packet is not present in the own RT, an adjacent RREQ packet in which the destination information on the packet is set.

If the GW 100 receives an adjacent RREP packet associated with the adjacent RREQ packet, the GW 100 sets the send source node of the adjacent RREP packet to the transfer destination and sends the data packet. In contrast, if the GW 100 does not receive an adjacent RREP packet, the GW 100 sends the data packet by using flooding.

The nodes 200 receive an adjacent RREQ packet from the GW 100 or from another node and sends, if the destination information that is set in the adjacent RREQ packet is present in the own RT, an adjacent RREP packet to the send source of the adjacent RREQ packet. In contrast, if the destination information that is set in the adjacent RREQ packet is not present in the own RT, the nodes 200 do not send the adjacent RREP packet.

The GW 100 and the nodes 200 according to the second embodiment send and receive an adjacent RREQ packet, an adjacent RREP packet, a data packet, a Hello packet, and the like. In a description below, an example of the data structure of each of the adjacent RREQ packet, the adjacent RREP packet, the data packet, and the hello packet will sequentially be described.

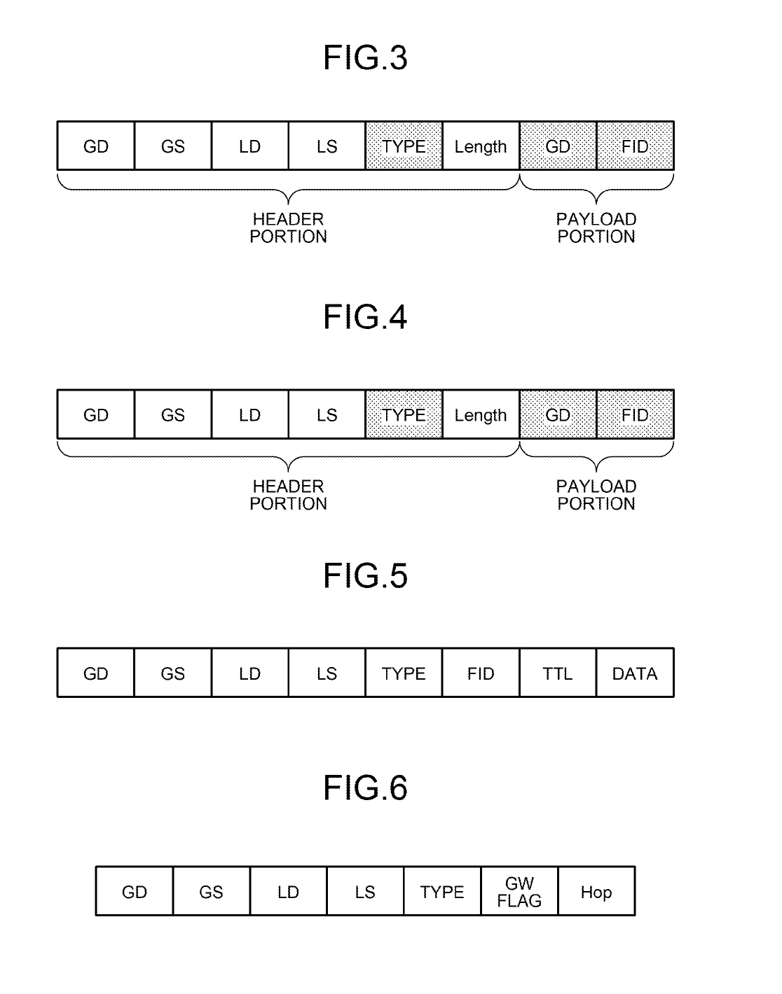

An example of the data structure of an adjacent RREQ packet will be described. FIG. 3 is a schematic diagram illustrating an example of the data structure of an adjacent RREQ packet according to the second embodiment. As illustrated in FIG. 3, the adjacent RREQ includes a header portion and a payload portion. The header portion includes GD, GS, LD, LS, TYPE, and Length. The payload portion includes GD and FID.

The header portion of an adjacent RREQ packet will be described. The GD indicates the destination address and, in the GD, a broadcast address is set. For example, the broadcast address is always “1”. The GS indicates the send source address of an adjacent RREQ packet and, for example, the address of the GW 100 is set therein. The LD indicates the transfer destination address of an adjacent RREQ packet and a broadcast address is set therein. In the LS, the transfer source address of the adjacent RREQ packet is set. The TYPE indicates the type of packet. The TYPE of the adjacent RREQ packet is “adjacent RREQ”. The Length indicates the length of the sum of the GD and the FID in the payload portion.

The payload portion of the adjacent RREQ packet will be described. In the GD in the payload portion, a destination address that is not present in the own RT is set. In the FID, information that is used to uniquely identify an adjacent RREQ packet is set.

An example of the data structure of an adjacent RREP packet will be described. FIG. 4 is a schematic diagram illustrating an example of the data structure of an adjacent RREP packet according to the second embodiment. As illustrated in FIG. 4, the adjacent RREP includes a header portion and a payload portion. The header portion includes GD, GS, LD, LS, TYPE, and Length. The payload portion includes GD and FID.

The header portion of an adjacent RREP packet will be described. The GD indicates the destination address and, in the GD, the send source address of an adjacent RREQ packet is set. In the GS, the send source address of an adjacent RREP packet is set. In the LD, the send source address of the adjacent RREP packet is set. In the LS, the send source address of the adjacent RREP packet is set. The TYPE indicates the type of packet. The TYPE of the adjacent RREP packet is “adjacent RREP”.

The payload portion of the adjacent RREP packet will be described. In the GD in the payload portion, the address of the GD in the payload portion of the adjacent RREQ packet is set. In the FID, information on the FID in the adjacent RREQ packet is set.

An example of the data structure of a data packet will be described. FIG. 5 is a schematic diagram illustrating an example of the data structure of a data packet according to the second embodiment. As illustrated in FIG. 5, the data packet includes GD, GS, LD, LS, TYPE, FID, TTL, and DATA. The GD indicates the destination address. The GS indicates the send source address. The LD indicates the transfer destination address. The LS indicates the transfer source address. The TYPE indicates the type of packet. The TYPE of the data packet is “Data”. In the FID, information that is used to uniquely identify a data packet is set. In time to live (TTL), a value that indicates the validity period of a packet is stored. In the DATA, for example, user data is stored.

An example of the data structure of a hello packet will be described. FIG. 6 is a schematic diagram illustrating an example of the data structure of a hello packet according to the second embodiment. As illustrated in FIG. 6, the hello packet includes GD, GS, LD, LS, TYPE, a GW flag, and Hop. In the GD, the address of the GW 100 is set. The GS indicates the send source address. The LD indicates the transfer destination address of the hello packet. The LS indicates the transfer source address of the hello packet. The TYPE indicates the type of packet. The TYPE of the hello packet is “Hello”. The GW flag is information indicating whether the send source of the hello packet is the GW 100. If the send source of a hello packet is the GW 100, the GW flag enters “on”. If the send source of a hello packet is other than the GW 100, the GW flag enters “off”. The Hop indicates a Hop count to the GW 100.

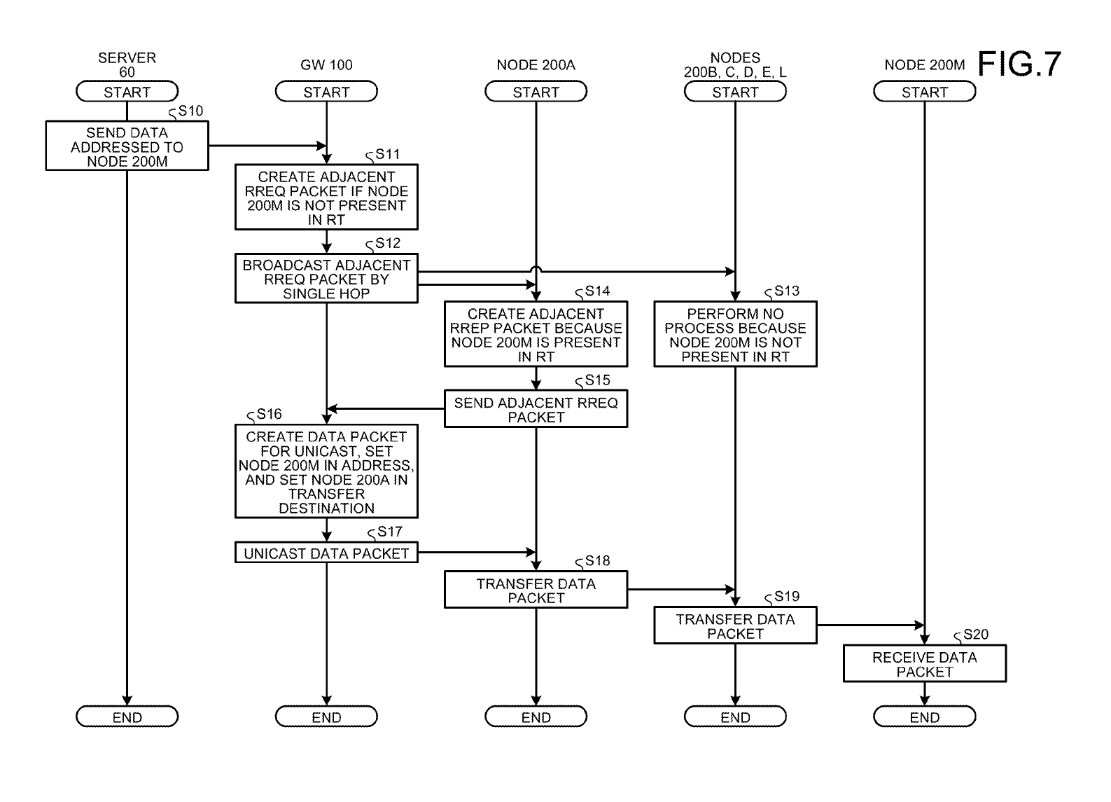

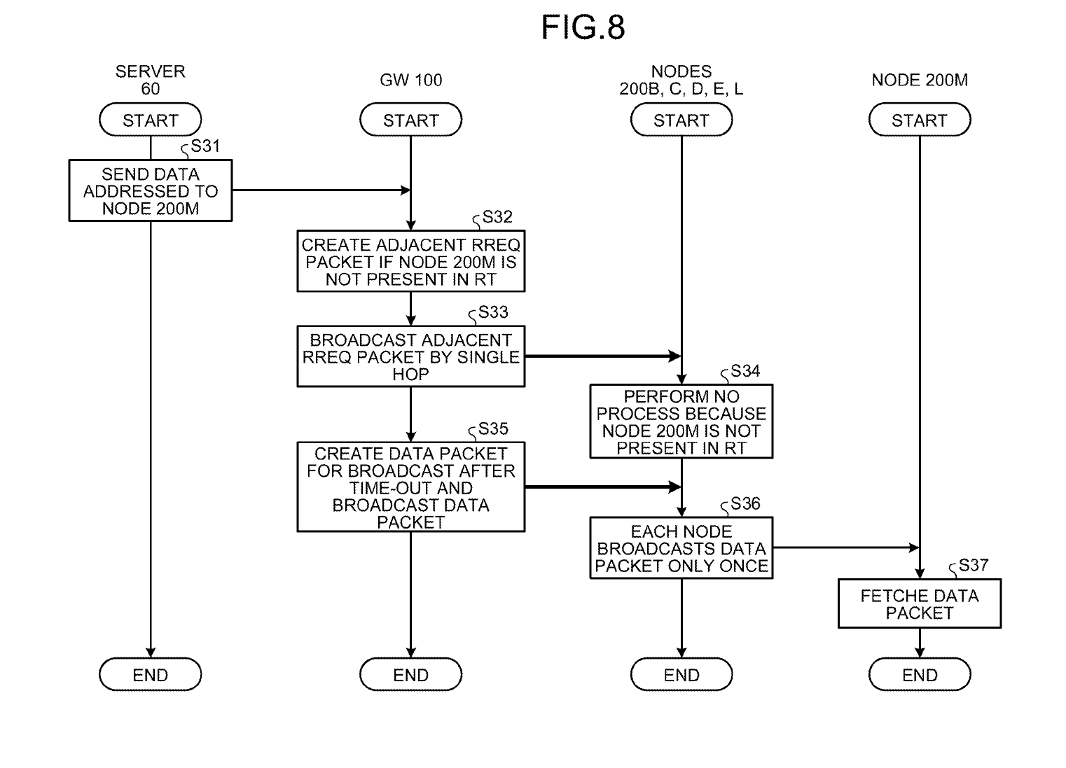

In the following, an example of the processing sequence of the ad hoc network illustrated in FIG. 2 will be described. FIGS. 7 and 8 are schematic diagrams each illustrating an example of a processing sequence of a data packet. For example, in FIG. 7, it is assumed that the entry registration of the node 200M is not present in the RT in the GW 100 and it is assumed that the entry registration of the node 200M is present in the RT in the node 200A. Furthermore, it is assumed that the nodes 200A, 200B, 200C, 200D, and 200E are adjacent nodes of the GW 100.

As illustrated in FIG. 7, the server 60 sends the data addressed to the node 200M to the GW 100 (Step S10). If the node 200M is not present in the RT, the GW 100 creates an adjacent RREQ packet (Step S11). At Step S11, the GW 100 sets the address of the node 200M in the GD in the payload portion of the adjacent RREQ packet.

The GW 100 broadcasts the adjacent RREQ packet by a single hop (Step S12). Because of the single hop broadcast performed at Step S12, the adjacent RREQ packet is sent to the nodes 200A, 200B, 200C, 200D, 200E, and 200L that are adjacent to the GW 100.

The nodes 200B, 200C, 200D, 200E, and 200L perform no process because the node 200M is not present in their own RT (Step S13). Because the node 200M is present in the RT in the node 200A, the node 200A creates an adjacent RREP packet (Step S14). The node 200A sends the adjacent RREP packet to the GW 100 (Step S15).

The GW 100 creates a data packet for unicast, sets the address of the node 200M in the GD in the data packet, and sets the address of the node 200A in the LD (Step S16). The GW 100 unicasts the data packet to the node 200A (Step S17).

The node 200A transfers the data packet received from the GW 100 to the node 200L (Step S18). At Step S18, the node 200A sets the address of the node 200M in the GD in the data packet and sets the address of the node 200L in the LD.

The node 200L transfers, to the node 200M, the data packet that has been transferred from the node 200A (Step S19). At Step S19, the node 200L sets the “node 200M” in the GD in the data packet and sets the “node 200M” in the LD. Then, the node 200M receives the data packet via the nodes 200A and 200L (Step S20).

As illustrated in FIG. 7, if the destination of the packet is not present in the RT in the GW 100, the GW 100 broadcasts an adjacent RREQ packet that is used to inquire the subject destination. If the GW 100 receives an adjacent RREP packet from one of the nodes 200 that is included in the RT in the GW 100, the GW 100 uses the send source of the adjacent RREP packet as the transfer destination of the data packet. Consequently, the GW 100 can send the data packet to the destination without performing the flooding.

In the following, FIG. 8 will be described. For example, in FIG. 8, it is assumed that the entry registration of the node 200M is not present in the RT in the GW 100 and it is assumed that the entry registration of the node 200M is not present in the RT in the nodes 200A, 200B, 200C, 200D, and 200E. Furthermore, it is assumed that the nodes 200A, 200B, 200C, 200D, and 200E are adjacent nodes of the GW 100.

As illustrated in FIG. 8, the server 60 sends the data addressed to the node 200M to the GW 100 (Step S31). If the node 200M is not present in the RT in the GW 100, the GW 100 creates an adjacent RREQ (Step S32). At Step S32, the GW 100 sets the “node 200M” in the GD in the payload portion of the adjacent RREQ packet.

The GW 100 broadcasts the adjacent RREQ packet by a single Hop (Step S33). Because of the single hop broadcast performed at Step S33, the adjacent RREQ packet is sent to the nodes 200A, 200B, 200C, 200D, 200E, and 200L that are adjacent to the GW 100.

The nodes 200A, 200B, 200C, 200D, 200E, and 200L do not any process because the node 200M is not in the RT (Step S34).

The GW 100 creates a data packet for a broadcast after a time-out has occurred and broadcasts the data packet (Step S35). At Step S35, the GW sets “node 200M” in the GD in the data packet and sets the broadcast address in the LD, thereby the GW creates the data packet that is used for the broadcast.

Each of the nodes 200A to 200E and the node 200L broadcasts the data packet only once (Step S36). Then, the node 200M fetches the data packet addressed to the own node 200M (Step S37).

As illustrated in FIG. 8, if the destination of the packet is not present in the own RT in the GW 100, the GW 100 broadcasts an adjacent RREQ packet that is used to inquiry the destination. Then, if the GW 100 does not receive an adjacent RREP before a time-out, the GW 100 sends a data packet by using flooding.

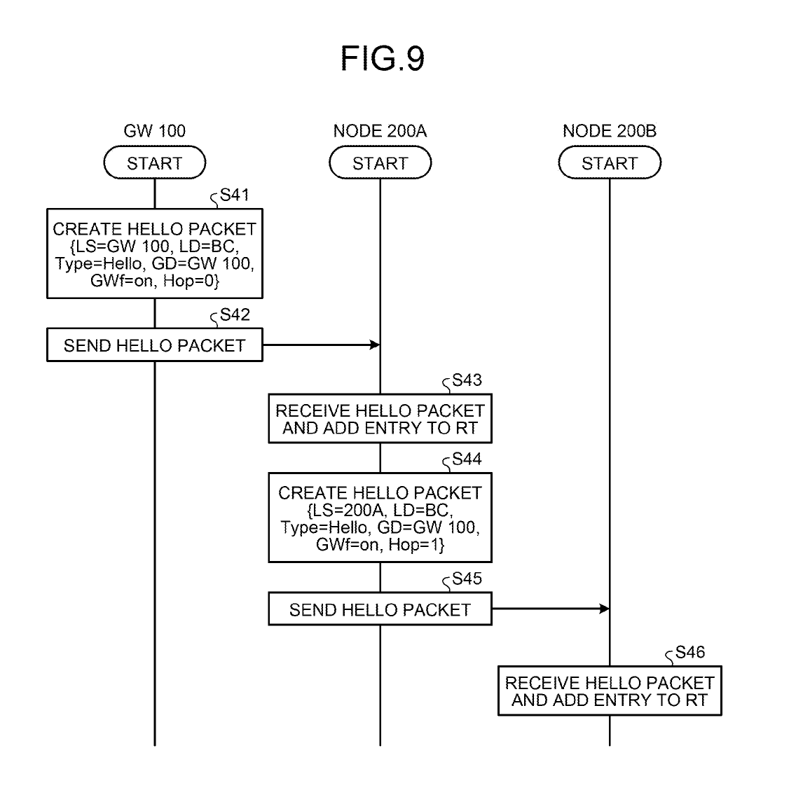

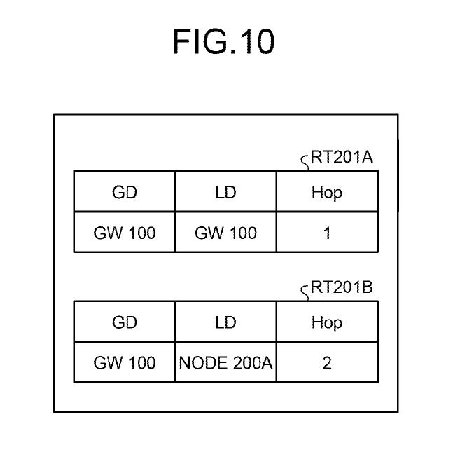

In the following, an example of the processing sequence of the path construction in the uplink direction to the GW 100 will be described. FIG. 9 is a schematic diagram illustrating an example of a processing sequence of path construction in the uplink direction to a GW. In FIG. 9, a description will be given by using, as an example, the GW 100 and the nodes 200A and 200B. FIG. 10 is a schematic diagram illustrating an example of an RT created at the time of path construction of the uplink direction to the GW. In FIG. 10, an RT 201A is the RT included in the node 200A. An RT 201B is the RT included in the node 200B.

As illustrated in FIG. 9, the GW 100 creates a hello packet (Step S41). At Step S41, the GW 100 sets the address of the GW 100 in the LS and sets the broadcast address in the LD. Hereinafter, the broadcast address is appropriately referred to as BC. Furthermore, the GW 100 sets the TYPE to “Hello” and sets the GW flag to “On”. The GW 100 sets the address of the GW 100 in the GD. Furthermore, the GW 100 sets the Hop to “0”.

The GW 100 sends a hello packet (Step S42). The node 200A receives the hello packet and adds an entry to the RT (Step S43). At Step S43, the node 200A adds the address of the GW 100 to the GD in the RT 201A, adds the address of the GW 100 to the LD, and adds “1” to the Hop. The node 200A adds the value of “1”, which is obtained by adding 1 to the value of the Hop included in the hello packet, to the Hop in the RT 201A.

The node 200A creates a hello packet (Step S44). At Step S44, the node 200A sets the address of the node 200A in the LS and sets the BC in the LD. The node 200A sets the TYPE to “Hello” and sets the GW flag to “On”. The node 200A sets the address of the GW 100 in the GD. Furthermore, the GW 100 sets the Hop included in the hello packet to the value “1” that is set in the Hop in the RT 201A.

The node 200A sends the hello packet (Step S45). The node 200B receives the hello packet and adds an entry to the RT (Step S46). At Step S46, the node 200B adds the address of the GW 100 to the GD in the RT 201B, adds the address of the node 200A to the LD in the RT 201B, and adds “2” to the Hop in the RT 201B. The node 200A adds the value of “2”, which is obtained by adding 1 to the value of the Hop included in the hello packet, to the Hop in the RT 201B.

The node 200 repeatedly performs the processes illustrated in FIG. 9, thereby path information in the uplink direction to the GW 100 is constructed.

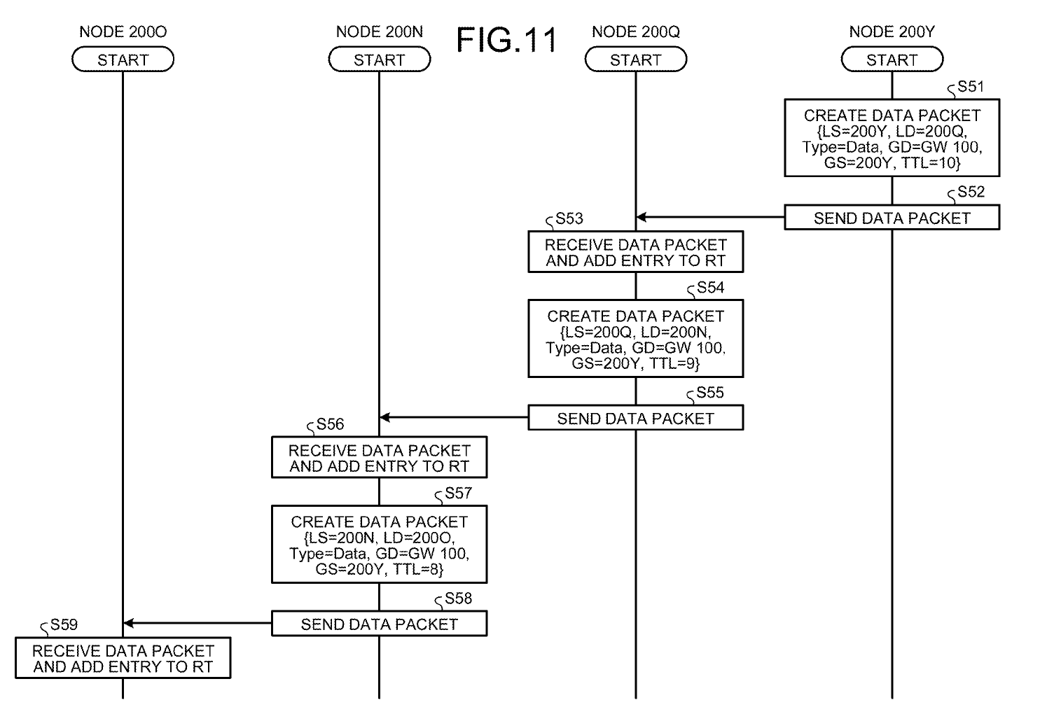

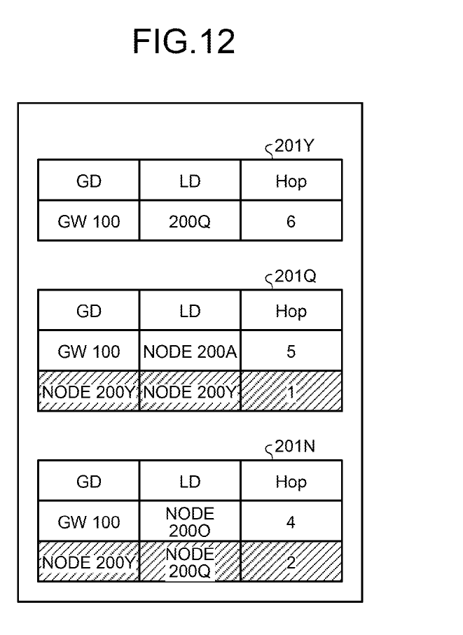

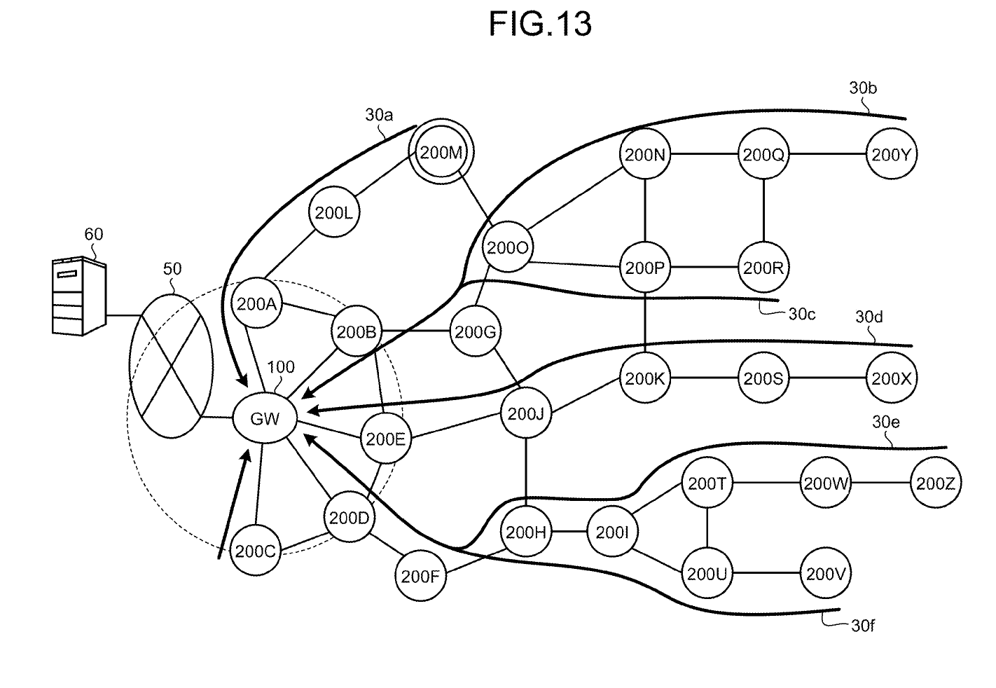

In the following, an example of the processing sequence of the path construction in the downlink direction will be described. FIG. 11 is a schematic diagram illustrating an example of a processing sequence of path construction in the downlink direction. In FIG. 11, a description will be given by using, as an example, the nodes 200O, 200N, 200Q, and 200Y. FIG. 12 is a schematic diagram illustrating an example of an RT created at the time of path construction of the downlink direction. In FIG. 12, an RT 201Y is the RT included in the node 200Y. An RT 201Q is the RT included in the node 200Q. An RT 201N is the RT included in the node 200N. It is assumed that the destination of the GW 100 is registered in the RTs in the nodes 200.

It is assumed that the nodes 100O, 200N, 200Q, and 200Y include the destination information on the GW 100 in their own RT obtained by the path construction in the uplink direction to the GW 100. As will be described below, by sending a data packet to the GW 100, the nodes 200 perform the path construction in the downlink direction.

As illustrated in FIG. 11, the node 200Y creates a data packet (Step S51). At Step S51, the node 200Y sets the address of the node 200Y in the LS included in the data packet and sets the address of the node 200Q in the LD. The node 200Y sets the TYPE to “Data”. The node 200Y sets the address of the GW 100 in the GD and sets the address of the node 200Y in the GS. The node 200Y sets the TTL to the initial value 10.

The node 200Y sends the data packet (Step S52). The node 200Q receives the data packet and adds an entry to the RT 201Q (Step S53). At Step S53, the node 200Q adds the address of the node 200Y in the GD in the RT 201Q, adds the address of the node 200Y in the LD in the RT 201Q, and adds “1” to the Hop in the RT 201Q. The node 200Q calculates the Hop of “1” by subtracting the value “9”, i.e., the value of “TTL-1” in the data packet, from the initial value “10” of the TTL.

The node 200Q creates a data packet (Step S54). At Step S54, the node 200Q sets the address of the node 200Q in the LS and sets the address of the node 200N in the LD. The node 200Q sets the TYPE to “Data”. The node 200Q sets the address of the GW 100 in the GD and sets the address of the node 200Y in the GS. The node 200Q sets, in the TTL, the value “9” obtained by subtracting 1 from the TTL that is included in the data packet received from the node 200Y.

The node 200Q sends the data packet (Step S55). The node 200N receives the data packet and adds an entry to the RT 201Q (Step S56). At Step S56, the node 200N adds the address of the node 200Y to the RT 201Q, adds the address of the node 200Q to the LD, and adds the Hop to “2”. The node 200N calculates the Hop “2” by subtracting the value of “8”, i.e., the value of “TTL-1” included in the data packet, from the initial value “10” of TTL.

The node 200N creates a data packet (Step S57). At Step S57, the node 200N sets the address of the node 200N in the LS and sets the address of the node 200O in the LD. The node 200N sets the TYPE to “DATA”. The node 200N sets the address of the GW 100 in the GD and sets the address of the node 200Y in the GS. The node 200N sets, in the TTL, the value “8” obtained by subtracting 1 from the TTL that is included in the data packet received from the node 200Q.

The node 200N sends the data packet (Step S58). The node O receives the data packet and adds an entry to an RT 201O (Step S59). A description of the process performed at Step S59 in detail will be omitted.

As described above, each of the nodes 200 sends a data packet addressed to the GW 100, thereby the destination is registered in the RT in each of the node 200. FIG. 13 is a schematic diagram illustrating an example of a transmission path of a data packet when path construction in the downlink direction is performed. As illustrated in FIG. 13, it is assumed that the data packet reached the GW 100 by a transmission paths 30a, 30b, 30c, 30d, 30e, and 30f. Then, for example, in the RT in the node 200A, entries of the GW 100 and the nodes 200L and 200M are registered. In the RT in the node 200B, entries of the GW 100 and the nodes 200G, 200N, 200O, 200P, 200Q, 200R, and 200Y are registered. In the RT in the node 200C, an entry of the GW 100 is registered. In the RT in the node 200D, entries of the GW 100 and the nodes 200F, 200H, 2001, 200T, 200W, 200Z, 200U, and 200V are registered. In the RT in the node E, entries of the GW 100 and the nodes 200J, 200K, 200S, and 200X are registered.

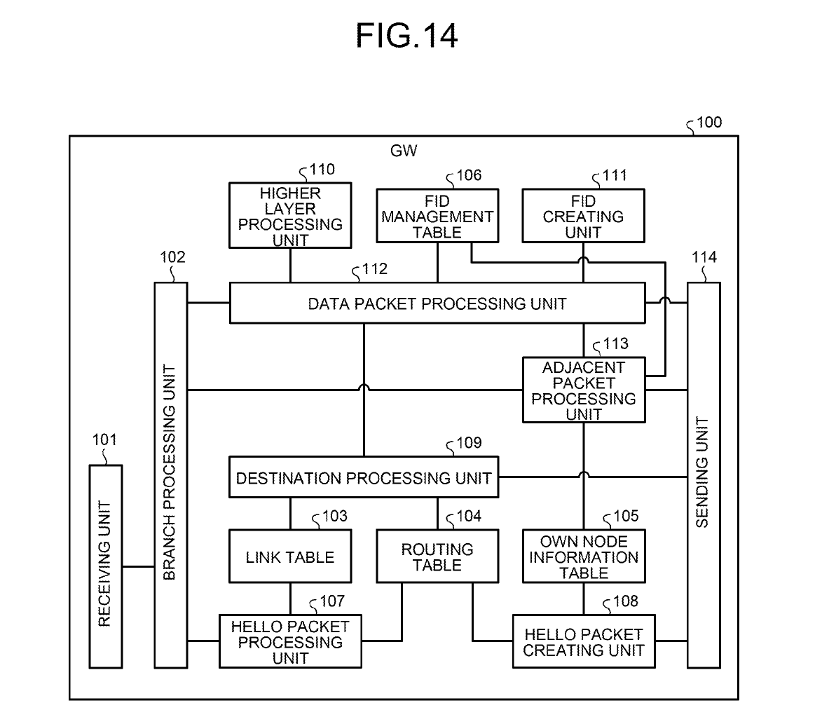

In the following, the configuration of the GW 100 and the node 200 according to the second embodiment will be described. Because the configuration of the GW 100 is the same as that of the node 200, here, the configuration of the GW 100 will be described. FIG. 14 is a functional block diagram illustrating the configuration of a GW according to the second embodiment.

As illustrated in FIG. 14, the GW 100 includes a receiving unit 101, a branch processing unit 102, a link table 103, a routing table 104, an own node information table 105, an FID management table 106, and a hello packet processing unit 107. Furthermore, the GW 100 includes a hello packet creating unit 108, a destination processing unit 109, a higher layer processing unit 110, an FID creating unit 111, a data packet processing unit 112, an adjacent packet processing unit 113, and a sending unit 114.

The receiving unit 101 is a processing unit that receives a packet sent from another node 200.

The branch processing unit 102 outputs, on the basis of the type of packet, a packet to the hello packet processing unit 107, the data packet processing unit 112, and the adjacent packet processing unit 113. If the TYPE included in the packet is “Hello”, the branch processing unit 102 outputs the packet to the hello packet processing unit 107. If the TYPE included in the packet is “DATA” or “DATA ACK”, the branch processing unit 102 outputs the packet to the data packet processing unit 112. If the TYPE included in the packet is “adjacent RREQ” or “adjacent RREP”, the branch processing unit 102 outputs the packet to the adjacent packet processing unit 113.

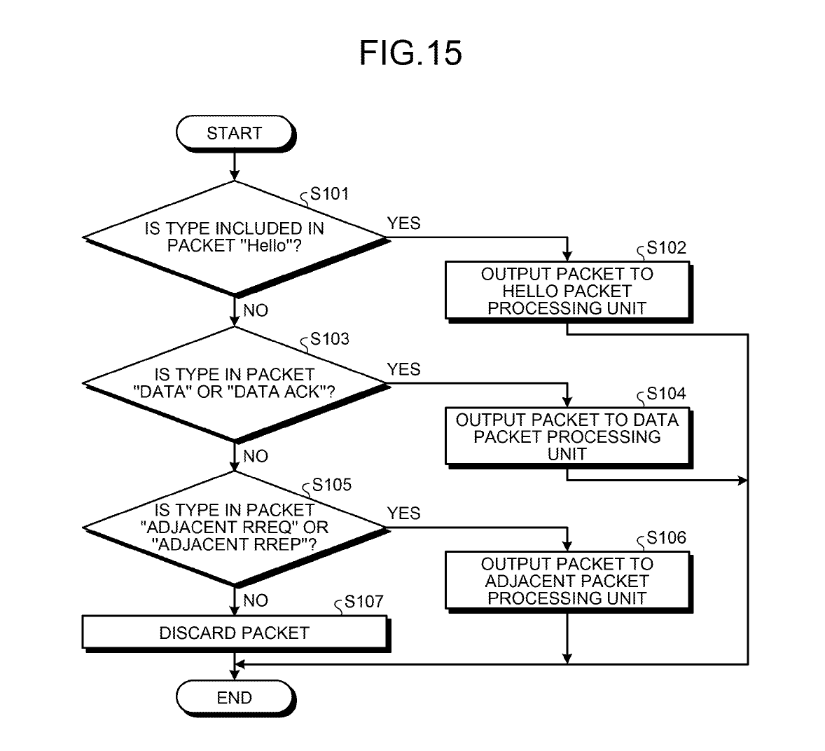

The flow of the process performed by the branch processing unit 102 will be described. FIG. 15 is a flowchart illustrating the flow of a process performed by a branch processing unit. As illustrated in FIG. 15, the branch processing unit 102 determines whether the TYPE included in the received packet is “Hello” (Step S101). If the TYPE included in the received packet is “Hello” (Yes Step S101), the branch processing unit 102 outputs the packet to the hello packet processing unit 107 (Step S102).

In contrast, if the TYPE included in the received packet is not “Hello” (No at Step S101), the branch processing unit 102 determines whether the TYPE in the packet is “DATA” or “DATA ACK” (Step S103). If the TYPE in the packet is “DATA” or “DATA ACK” (Yes at Step S103), the branch processing unit 102 outputs the packet to the data packet processing unit 112 (Step S104).

In contrast, if the TYPE in the packet is not “DATA” or “DATA ACK” (No at Step S103), the branch processing unit 102 determines whether the TYPE in the packet is “adjacent RREQ” or “adjacent RREP” (Step S105). If the TYPE in the packet is “adjacent RREQ” or “adjacent RREP” (Yes at Step S105), the branch processing unit 102 outputs the packet to the adjacent packet processing unit 113 (Step S106).

In contrast, if the TYPE in the packet is not “adjacent RREQ” or “adjacent RREP” (No at Step S105), the branch processing unit 102 discards the packet (Step S107).

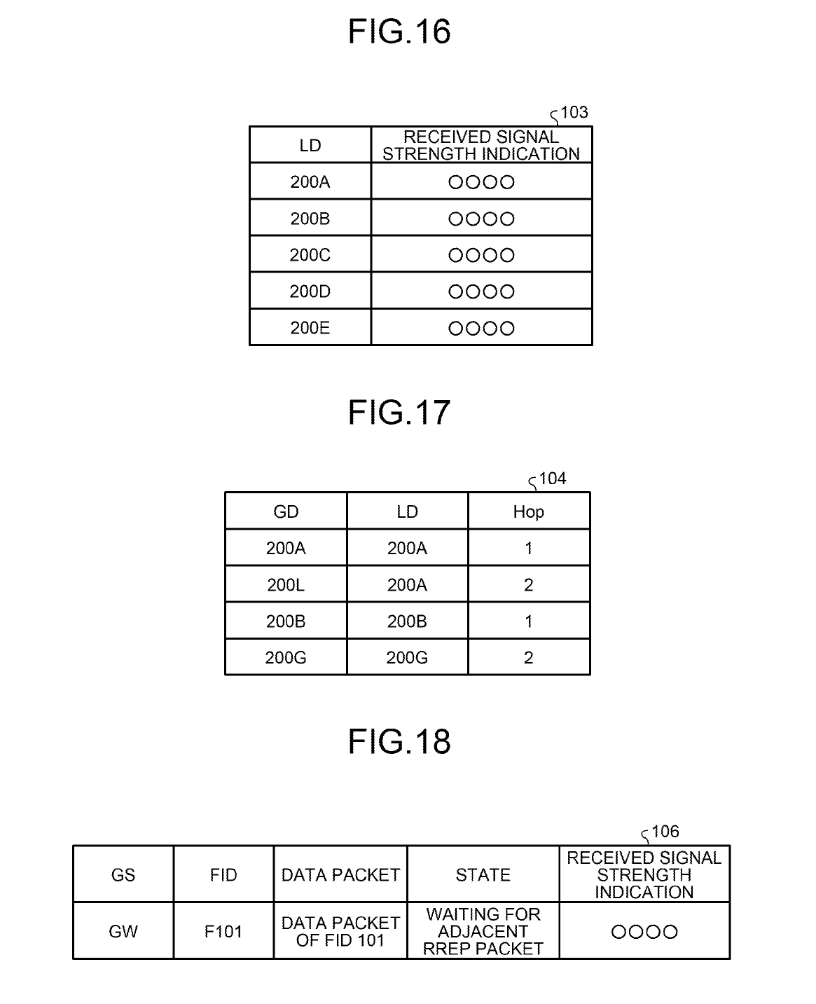

The link table 103 is a table that holds information on the nodes adjacent to the GW 100. FIG. 16 is a schematic diagram illustrating an example of the data structure of a link table. For example, as illustrated in FIG. 16, the link table 103 stores therein, in an associated manner, the LD of an adjacent node and received signal strength indication (RSSI).

The routing table 104 is a table that holds the transfer destination that is used to send a packet to the destination. FIG. 17 is a schematic diagram illustrating an example of the data structure of a routing table. For example, as illustrated in FIG. 17, the routing table 104 associates the GD, the LD, and the Hop. In the GD, the destination address of a packet is registered. In the LD, the address of the transfer destination that is used to send a packet to the destination is registered. The Hop indicates a Hop count to the destination of the packet. In the example illustrated in FIG. 17, if the destination of the packet is the node 200L, the transfer destination of the packet is the node 200A.

The own node information table 105 holds various kinds of information related to the own node.

The FID management table 106 holds information that is used to resend a data packet, to detect a loop, to perform backtracking. FIG. 18 is a schematic diagram illustrating an example of the data structure of an FID management table. As illustrated in FIG. 18, the FID management table 106 stores therein, in an associated manner, the GS, the FID, a data packet, a state, and received signal strength indication (RSSI). The GS indicates the send source address of a packet. The FID is information that is used to uniquely identify a packet. The data packet is data of a data packet. The state indicates the state of a packet. For example, if a state is the wait state of an adjacent RREP packet, the state indicates “waiting for an adjacent RREP packet”. The received signal strength indication indicates the received signal strength indication obtained when an adjacent RREP packet is received.

The hello packet processing unit 107 is a processing unit that updates the link table 103 and the routing table 104 on the basis of hello packet information.

The process in which the hello packet processing unit 107 updates the link table 103 will be described. The hello packet processing unit 107 sets the LS included in a hello packet to the LD included in the link table 103 and associates them with the received signal strength indication. The hello packet processing unit 107 measures the received signal strength indication of the hello packet and set the measurement result in the link table 103.

The process in which the hello packet processing unit 107 updates the routing table 104 will be described. The hello packet processing unit 107 updates the routing table 104 by using the same method as that used in path construction in the uplink direction to the GW illustrated in FIG. 9.

The hello packet creating unit 108 periodically creates a hello packet from the own node information table 105 and the routing table 104 and outputs the created hello packet to the sending unit 114. The process of creating a hello packet performed by the hello packet creating unit 108 is the same as that used for the path construction in the uplink direction to the GW illustrated in FIG. 9 and used for the path construction in the downlink direction illustrated in FIG. 11.

The destination processing unit 109 is a processing unit that compares the destination of a packet with the link table 103 and the routing table 104 and that determines the transfer destination. For example, if a plurality of transfer destinations is present in the routing table 104, the destination processing unit 109 may also select, as the transfer destination with priority, a node with greater received signal strength indication in the link table 103.

The higher layer processing unit 110 is a processing unit that performs a final process of communication performed by using a data packet.

The FID creating unit 111 is a processing unit that creates an FID that is used to uniquely identify a data packet. By using a combination of the FID and a send source address, a packet is uniquely specified.

The data packet processing unit 112 is a processing unit that performs various processes when a data packet is received. If the data packet processing unit 112 receives a data packet addressed to the own node or if the data packet processing unit 112 receives a first broadcast data, the data packet processing unit 112 notifies the higher layer processing unit 110 of that state. If the data packet processing unit 112 receives both the same data packets, the data packet processing unit 112 discards the data packets.

If the destination of a data packet is other than the own node, the data packet processing unit 112 refers to the FID management table 106 and performs a resend, loop detection, and backtrack detection. Furthermore, when the data packet processing unit 112 transfers a data packet, the data packet processing unit 112 acquires the transfer destination from the destination processing unit 109 and notifies the sending unit 114 of the acquired destination.

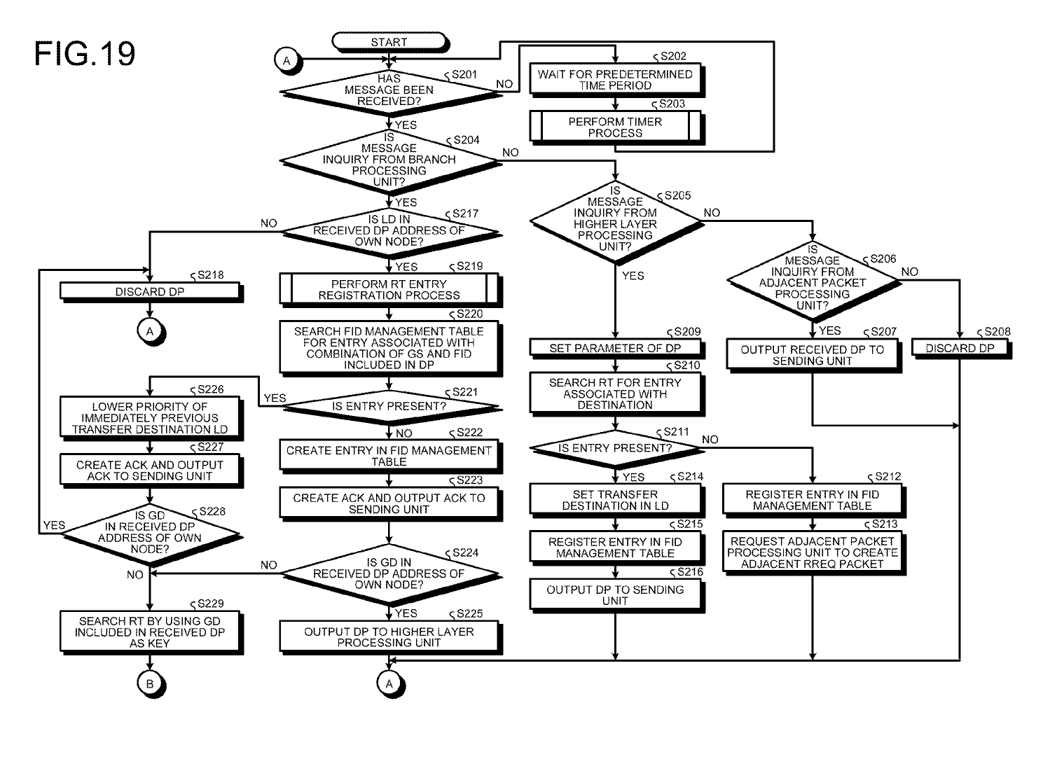

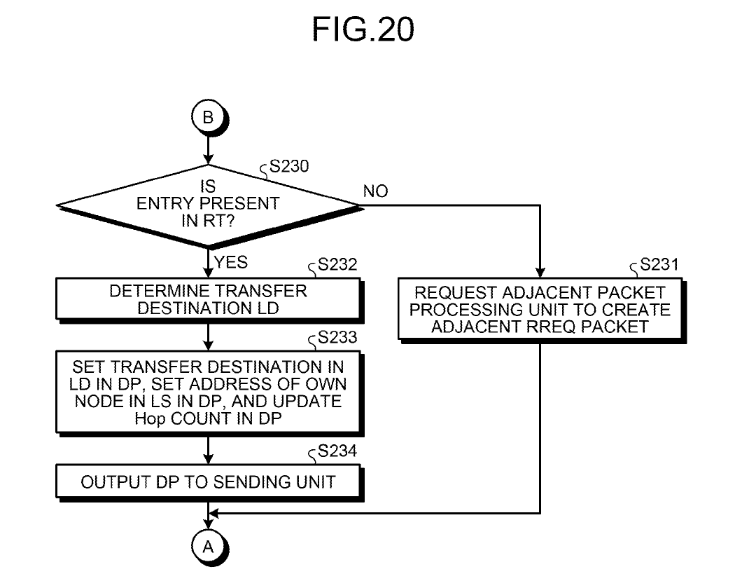

Here, the process performed by the data packet processing unit 112 will be specifically described. FIGS. 19 and 20 are flowcharts each illustrating the flow of a process performed by a data packet processing unit. In FIGS. 19 and 20, a data packet is referred to as a DP. As illustrated in FIG. 19, the data packet processing unit 112 determines whether a message has been received (Step S201).

If the data packet processing unit 112 does not receive a message (No at Step S201), the data packet processing unit 112 waits for predetermined time period (Step S202), performs a timer process (Step S203), and proceeds to Step S21.

If the data packet processing unit 112 receives a message (Yes at Step S201), the data packet processing unit 112 determines whether the message is an inquiry from the branch processing unit 102 (Step S204).

If the message is not an inquiry from the branch processing unit 102 (No at Step S204), the data packet processing unit 112 determines whether the message is inquiry from the higher layer processing unit 110 (Step S205). If the message is not an inquiry from the higher layer processing unit 110 (No at Step S205), the data packet processing unit 112 determines whether the message is an inquiry from the adjacent packet processing unit 113 (Step S206).

If the message is not an inquiry from the adjacent packet processing unit 113 (No at Step S206), the data packet processing unit 112 discards the DP (Step S208) and proceeds to Step S201. In contrast, if the message is an inquiry from the adjacent packet processing unit 113 (Yes at Step S206), the data packet processing unit 112 outputs the received DP to the sending unit 114 (Step S207) and proceeds to Step S201. At Step S207, the LS included in the adjacent RREP packet that is acquired from another node 200 is set in the LD included in the DP acquired from the adjacent packet processing unit 113 by the data packet processing unit 112.

A description will be given here by referring back to Step S205a. If the message is an inquiry from the higher layer processing unit 110 (Yes at Step S205), the data packet processing unit 112 sets the parameter of a DP (Step S209). At Step S209, the data packet processing unit 112 sets the address of the own node in the GS in the DP and sets, in the GD, the destination address that is specified by the higher layer processing unit 110. The data packet processing unit 112 sets the address of the own node in the LS included in the DP and sets the initial value of a Hop count in the Hop. The data packet processing unit 112 sets information on the FID created by the FID creating unit 111 to the FID included in the DP.

By using the destination processing unit 109, the data packet processing unit 112 searches the RT 104 for an entry associated with the destination (Step S210).

If no entry is present (No at Step S211), the data packet processing unit 112 registers an entry in the FID management table 106 (Step S212). The data packet processing unit 112 requests the adjacent packet processing unit 113 to create an adjacent RREQ packet (Step S213) and proceeds to Step S201.

In contrast, if an entry is present (Yes at Step S211), the data packet processing unit 112 sets the transfer destination in the LD in the DP (Step S214) and registers the entry in the FID management table 106 (Step S215). The data packet processing unit 112 outputs the DP to the sending unit 114 (Step S216) and proceeds to Step S201.

A description will be given here by referring back to Step S204. If the message is an inquiry from the branch processing unit 102 (Yes at Step S204), the data packet processing unit 112 determines whether the LD in the received DP is the address of the own node (Step S217). If the LD in the received DP is not the address of the own node (No at Step S217), the data packet processing unit 112 discards the DP (Step S218) and proceeds to Step S201.

In contrast, if the LD in the received DP is the address of the own node (Yes at Step S217), the data packet processing unit 112 performs the RT entry registration process (Step S219). At Step S219, the data packet processing unit 112 registers an entry in the RT by using the same method as that used in the path construction in the downlink direction illustrated in FIG. 11.

The data packet processing unit 112 searches the FID management table 106 for an entry associated with the combination of the GS and the FID included in the DP (Step S220). If no entry is present (No at Step S221), the data packet processing unit 112 creates an entry in the FID management table 106 (Step S222). The data packet processing unit 112 creates an ACK and outputs the ACK to the sending unit 114 (Step S223).

The data packet processing unit 112 determines whether the GD in the received DP is the address of the own node (Step S224). If the GD in the received DP is the address of the own node (Yes at Step S224), the data packet processing unit 112 outputs the DP to the higher layer processing unit 110 (Step S225) and proceeds to Step S201.

In contrast, if the GD in the received DP is not the address of the own node (No at Step S224), the data packet processing unit 112 proceeds to Step S229.

A description will be given here by referring back to Step S221. If an entry is present (Yes at Step S221), the data packet processing unit 112 lowers the priority of the immediately previous transfer destination (Step S226). The data packet processing unit 112 creates an ACK and outputs the ACK to the sending unit 114 (Step S227).

The data packet processing unit 112 determines whether the GD in the received DP is the address of the own node (Step S228). If the GD in the received DP is the address of the own node (Yes at Step S228), the data packet processing unit 112 proceeds to Step S218.

In contrast, if in the received DP is not the address of the own node (No at Step S228), the data packet processing unit 112 uses the destination processing unit 109 and searches the RT 104 by using the GD included in the DP as a key (Step S229). The data packet processing unit 112 proceeds to the process at Step S230 illustrated in FIG. 20.

In FIG. 20, if no entry is present in the RT 104 (No at Step S230), the data packet processing unit 112 requests the adjacent packet processing unit 113 to create an adjacent RREQ packet (Step S231), and proceeds to Step S201 illustrated in FIG. 19.

In contrast, if an entry is present in the RT 104 (Yes at Step S230), the data packet processing unit 112 determines the transfer destination LD (Step S232). The data packet processing unit 112 sets the transfer destination in the LD in the DP, sets the address of the own node in the LS in the DP, and updates the Hop count in the DP (Step S233). The data packet processing unit 112 outputs the DP to the sending unit 114 (Step S234) and proceeds to Step S201 illustrated in FIG. 19.

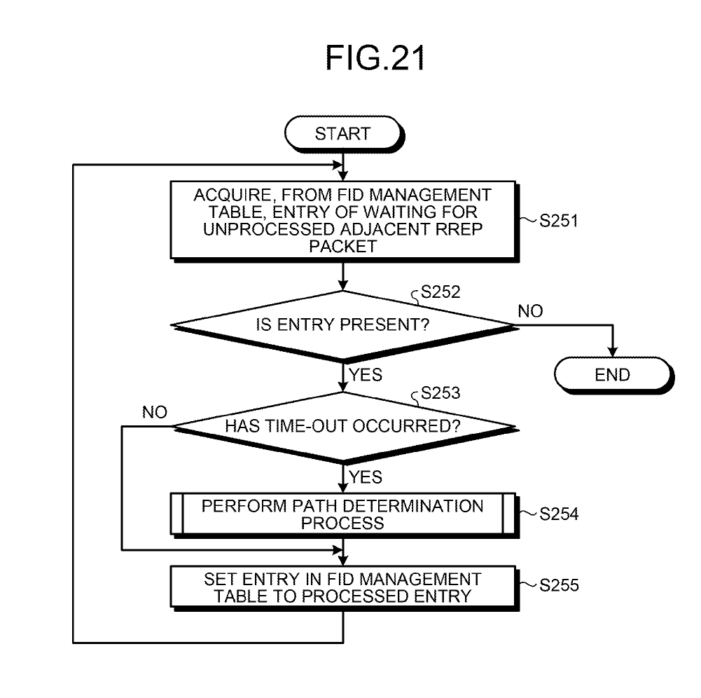

In the following, a description will be given of the flow of the timer process indicated at Step S203 illustrated in FIG. 19. FIG. 21 is a flowchart illustrating an example of the flow of a timer process. As illustrated in FIG. 21, the data packet processing unit 112 acquires, from the FID management table 106, an entry that indicates waiting for an unprocessed adjacent RREP packet (Step S251).

If no entry is present (No at Step S252), the data packet processing unit 112 ends the timer process. In contrast, if an entry is present (Yes at Step S252), the data packet processing unit 112 determines whether a time-out has occurred (Step S253).

If a time-out has not occurred (No at Step S253), the data packet processing unit 112 proceeds to Step S255.

In contrast, if a time-out has occurred (Yes at Step S253), the data packet processing unit 112 performs the path determination process (Step S254). At Step S254, the data packet processing unit 112 sets the broadcast addresses in the destination of the DP and returns the destination. Furthermore, the data packet processing unit 112 sets the LS of the entry in the FID management table 106 to the destination included in the DP.

The data packet processing unit 112 sets the entry in the FID management table 106 to a processed entry (Step S255) and proceeds to Step S251.

A description will be given here by referring back to FIG. 14. The adjacent packet processing unit 113 is a processing unit that processes an adjacent RREQ packet and an adjacent RREP packet received from the other nodes 200. If the destination of the packet is not present in the RT 104, the adjacent packet processing unit 113 broadcasts, to adjacent nodes, an adjacent RREQ packet in which the destination of the packet is set. If the adjacent packet processing unit 113 receives an adjacent RREP packet associated with an adjacent RREQ packet, the adjacent packet processing unit 113 sets the send source node of the adjacent RREP packet to the transfer destination and sends the data packet. In contrast, if the adjacent packet processing unit 113 does not receive an adjacent RREP packet, the adjacent packet processing unit 113 sends the data packet by using flooding.

Furthermore, the adjacent packet processing unit 113 receives an adjacent RREQ packet from one of the other nodes 200 and, if the destination that is set in the adjacent RREQ packet is present in the RT 104, the adjacent packet processing unit 113 sends the adjacent RREP packet to the node of the send source indicated in the adjacent RREQ packet. In contrast, if destination information that is set in the adjacent RREQ packet is not present in the RT 104 the adjacent packet processing unit 113 does not send the adjacent RREP packet.

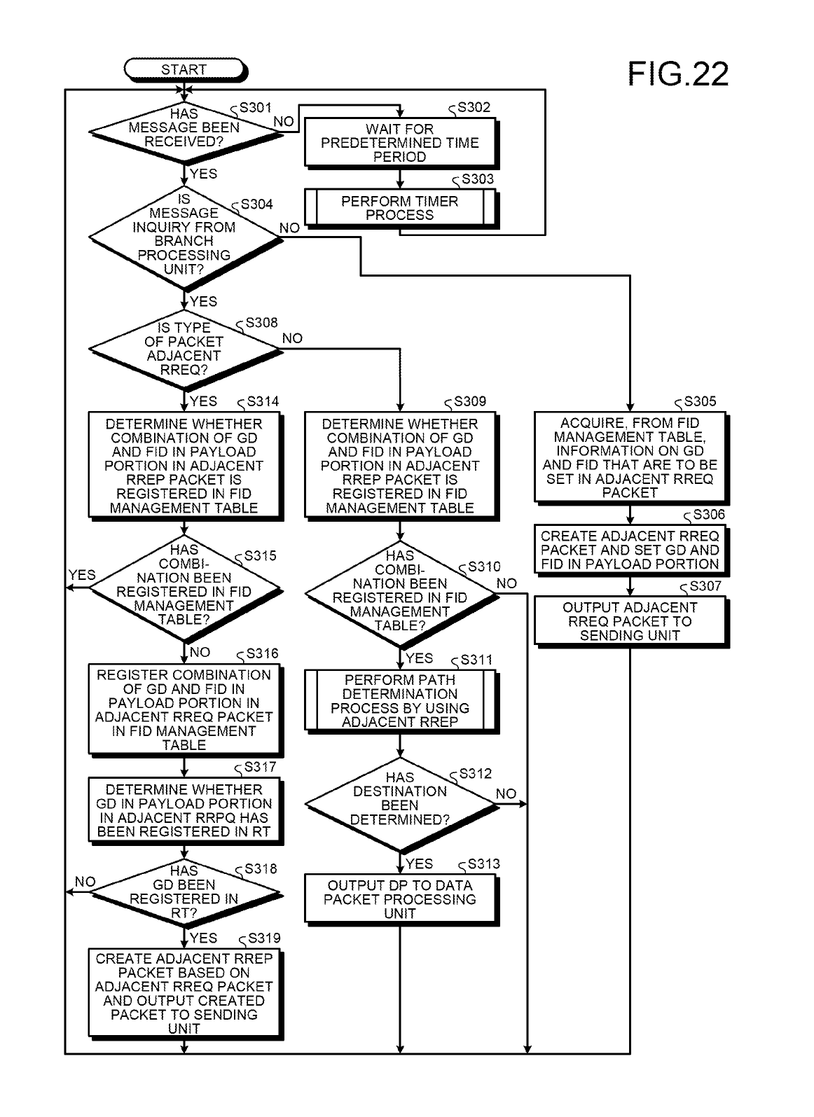

The process performed by the adjacent packet processing unit 113 will be specifically described. FIG. 22 is a flowchart illustrating the flow of a process performed by an adjacent packet processing unit. As illustrated in FIG. 22, the adjacent packet processing unit 113 determines whether a message has been received (Step S301). If a message has not been received (No at Step S301), the adjacent packet processing unit 113 waits for predetermined time period (Step S302), performs the timer process (Step S303), and proceeds to Step S301.

In contrast, if a message has been received (Yes at Step S301), the adjacent packet processing unit 113 determines whether the message is an inquiry from the branch processing unit 102 (Step S304). If the message is an inquiry from the branch processing unit 102 (No at Step S304), the adjacent packet processing unit 113 acquires, from the FID management table 106, information on the GD and the FID that are set in the adjacent RREQ packet (Step S305). At Step S304, if an inquiry from the data packet processing unit 112 has been received, this state indicates that the GD in the data packet is not present in the RT 104.

The adjacent packet processing unit 113 creates an adjacent RREQ packet and sets the GD and the FID in the payload portion (Step S306). The adjacent packet processing unit 113 outputs the adjacent RREQ packet to the sending unit 114 (Step S307) and proceeds to Step S301.

A description will be given here by referring back to Step S304. If the message is an inquiry from the branch processing unit 102 (Yes at Step S304), the adjacent packet processing unit 113 determines whether the type of packet is “adjacent RREQ” (Step S308).

If the type of packet is “adjacent RREP” (No at Step S308), the adjacent packet processing unit 113 determines whether a combination of the GD and the FID in the payload portion in the adjacent RREP packet has been registered in the FID management table 106 (Step S309). If the combination has not been registered in the FID management table 106 (No at Step S310), the adjacent packet processing unit 113 proceeds to Step S301.

In contrast, if the combination has been registered in the FID management table 106 (Yes at Step S310), the adjacent packet processing unit 113 performs the path determination process by using the adjacent RREP (Step S311). The adjacent packet processing unit 113 determines whether the destination has been determined (Step S312). If the destination has not been determined (No at Step S312), the adjacent packet processing unit 113 proceeds to Step S301.

In contrast, if the destination has been determined (Yes at Step S312), the adjacent packet processing unit 113 outputs the DP to the data packet processing unit 112 (Step S313) and proceeds to Step S301.

A description will be given here by referring back to Step S308. If the type is “adjacent RREQ” (Yes at Step S308), the adjacent packet processing unit 113 proceeds to Step S314. The adjacent packet processing unit 113 determines whether the combination of the GD and the FID in the payload portion in the adjacent RREQ packet has been registered in the FID management table 106 (Step S314).

If the combination has been registered in the FID management table 106 (Yes at Step S315), the adjacent packet processing unit 113 proceeds to Step S301.

In contrast, if the combination has not been registered in the FID management table 106 (No at Step S315), the adjacent packet processing unit 113 registers the combination of the GD and the FID in the payload portion in the adjacent RREQ packet in the FID management table 106 (Step S316).

The adjacent packet processing unit 113 determines whether the GD in the payload portion in the adjacent RRPQ has been registered in the RT 104 (Step S317). If the GD has not been registered in the RT 104 (No at Step S318), the adjacent packet processing unit 113 proceeds to Step S301.

In contrast, if the GD has been registered in the RT 104 (Yes at Step S318), the adjacent packet processing unit 113 creates an adjacent RREP packet on the basis of the adjacent RREQ packet and outputs the created adjacent RREP packet to the sending unit 114 (Step S319). The process performed at Step S319 will be specifically described. The adjacent packet processing unit 113 sets the send source address of the adjacent RREQ packet in the GD included in the adjacent RREP packet. The adjacent packet processing unit 113 sets the address of the own node in the GS included in the adjacent RREP packet. The adjacent packet processing unit 113 sets the send source address of the adjacent RREQ packet in the LD included in the adjacent RREP packet. The adjacent packet processing unit 113 sets the address of the own node in the LS in the adjacent RREP packet. The adjacent packet processing unit 113 sets “adjacent RREP” in the TYPE included in the adjacent RREP packet and sets the magnitude of the payload in the Length. The adjacent packet processing unit 113 sets information on the payload in the adjacent RREQ packet to the payload in the adjacent RREP packet.

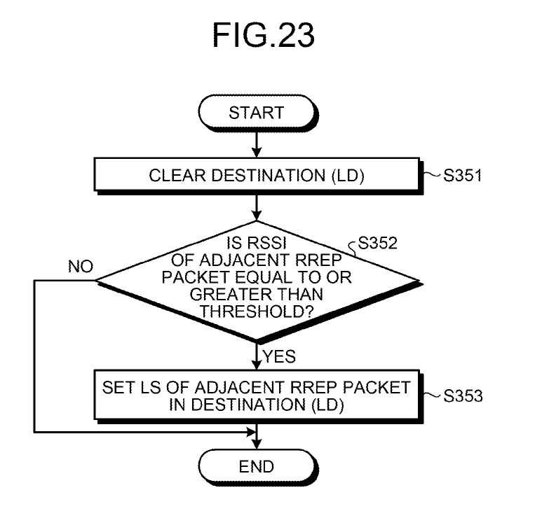

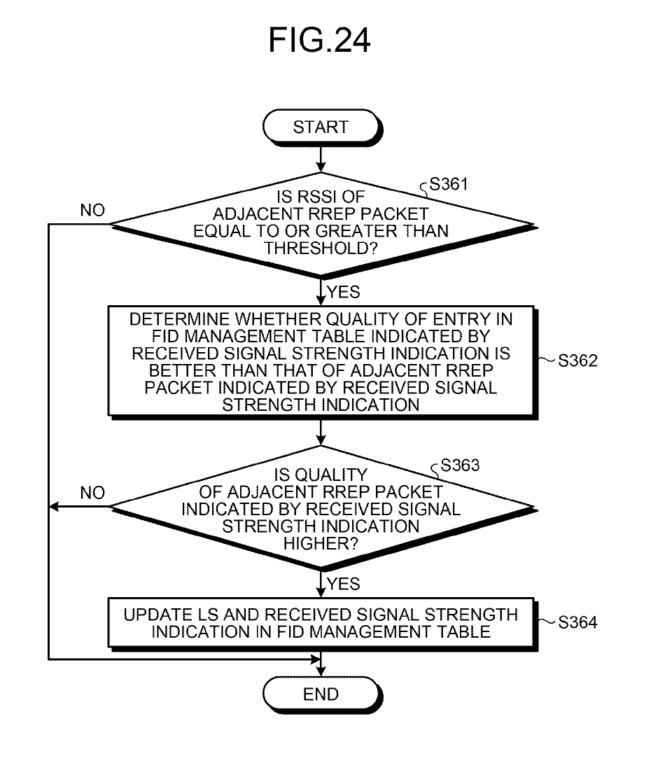

In the following, a description will be given of an example of a path determination process is performed by using the adjacent RREP at Step S313 illustrated in FIG. 22. FIGS. 23 and 24 are flowcharts each illustrating the flow of a path determination process performed by using an adjacent RREP. The adjacent packet processing unit 113 sequentially performs the processes illustrated in FIGS. 23 and 24.

As illustrated in FIG. 23, the adjacent packet processing unit 113 clears the destination (LD) (Step S351) and determines whether the RSSI of the adjacent RREP packet is equal to or greater than a threshold (Step S352). If the RSSI of the adjacent RREP packet is less than the threshold (No at Step S352), the adjacent packet processing unit 113 ends the process before the destination has not been determined.

In contrast, if the RSSI of the adjacent RREP packet is equal to or greater than the threshold (Yes at Step S352), the adjacent packet processing unit 113 sets the LS in the destination (LD) in the adjacent RREP packet (Step S353) and ends the process.

As illustrated in FIG. 24, the adjacent packet processing unit 113 determines whether the RSSI of the adjacent RREP packet is equal to or greater than the threshold (Step S361). If the RSSI of the adjacent RREP packet is less than the threshold (No at Step S361), the adjacent packet processing unit 113 ends the process.

If the RSSI of the adjacent RREP packet is equal to or greater than the threshold (Yes at Step S361), the adjacent packet processing unit 113 determines whether the quality of the entry in the FID management table 106 indicated by the received signal strength indication is higher than that of the adjacent RREP packet indicated by the received signal strength indication (Step S362).

If the quality of the adjacent RREP packet indicated by the received signal strength indication is worse (No at Step S363), the adjacent packet processing unit 113 ends the process. In contrast, if the quality of the adjacent RREP packet indicated by the received signal strength indication is high (Yes Step S363), the adjacent packet processing unit 113 updates the GS and the RSSI in the FID management table 106 (Step S364).

A description will be given here by referring back to FIG. 14. The sending unit 114 is a processing unit that sends various packets acquired from the data packet processing unit 112, the adjacent packet processing unit 113, and the hello packet creating unit 108.

In the following, a processing sequence performed when the GW 100 sends a data packet to the node 200M will be described. It is assumed that the destination of the node 200M is not registered in the RT 104 in the GW 100. Furthermore, it is assumed that the associated entry is not registered in the FID management table 106. In this case, each of the processing units in the GW 100 sequentially performs the processes indicated by (1-1) to (1-8), which will be described below.

(1-1) The data packet processing unit 112 creates an entry in the FID management table 106 in response to receiving a notification from the destination processing unit 109 indicating that no transfer destination is indicated. (1-2) The data packet processing unit 112 acquires an FID from the FID creating unit 111.

(1-3) The adjacent packet processing unit 113 registers the address of the GW 100 and the FID, which are acquired from the FID creating unit 111, in the GS and the FID, respectively, in the entry in the FID management table 106. (1-4) The adjacent packet processing unit 113 registers a packet that is to be sent to the node 200M in the packet data that is the entry in the FID management table 106.

(1-5) The adjacent packet processing unit 113 creates an adjacent RREQ packet, sets the address of the node 200M in the GD in the payload, and sets the FID acquired from the FID creating unit 111 in the FID in the payload. (1-6) The data packet processing unit 112 sets the entry state in the FID management table 106 to “waiting for an adjacent RREP”.

(1-7) The data packet processing unit 112 sets a timer used for waiting for an adjacent RREP (not illustrated). (1-8) The adjacent packet processing unit 113 outputs the adjacent RREQ packet to the sending unit 114 and the adjacent RREQ packet is broadcasted to each of the adjacent nodes.

In the following, a description will be given of a processing sequence of the GW 100 performed when, after the processes indicated by (1-8) described above are performed, an adjacent RREP packet is received from the node 200A. In this case, each of the processing units in the GW 100 performs the processes indicated by (2-1) to (2-6), which will be described below.

(2-1) The adjacent packet processing unit 113 uses the GS and the FID in the adjacent RREP packet as a key and acquires an associated entry in the FID management table 106. (2-2) The adjacent packet processing unit 113 acquires the data packet registered in the entry and sets, in the LD in the data packet, the address of the node 200A that is the send source of the adjacent RREP packet. Furthermore, the adjacent packet processing unit 113 sets the address of the own node in both the GS and the LS in the data packet. Furthermore, the adjacent packet processing unit 113 sets the address of the node 200M that is the destination node in the GD in the data packet. Then, the adjacent packet processing unit 113 outputs the data packet to the data packet processing unit 112.

(2-3) The data packet processing unit 112 resets the timer that is used for waiting for the adjacent RREP (not illustrated). (2-4) The data packet processing unit 112 sets the entry state in the FID management table 106 to “waiting for an ACK”.

(2-5) The data packet processing unit 112 sets a timer that is used for an ACK (not illustrated). (2-6) The data packet processing unit 112 outputs the data packet to the sending unit 114.

Consequently, a unicast data packet is sent from the GW 100 to the node 200A. The node 200A that has received the data packet transfers the data packet to the node 200L in accordance with the entries in the own RT. The node 200L transfers the data packet to the node 200M in accordance with the entries in the own RT. By doing so, the node 200M receives the data packet sent form the GW 100.

In the following, the advantage of the ad hoc network according to the second embodiment will be described. For example, if the destination of a packet is not present in the own RT in the GW 100, the GW 100 broadcasts an adjacent RREQ packet that is used to inquire the destination. If the GW 100 receives an adjacent RREP packet from one of the nodes 200 that includes therein the destination in the RT in the GW 100, the GW 100 sets the send source of the adjacent RREP packet to the transfer destination of the data packet. Consequently, the data packet can be sent to the destination without performing flooding.

Furthermore, if one of the nodes 200 receives an adjacent RREQ packet from another node or from the GW 100 and if the destination that is set in the adjacent RREQ packet is present in the RT in the own node, the subject node 200 sends the adjacent RREP packet to the node that is the send source of the adjacent RREQ packet. Consequently, if an entry of the subject destination is present in the RT in the own device, it is possible to prevent the broadcasting from being performed by the GW 100.

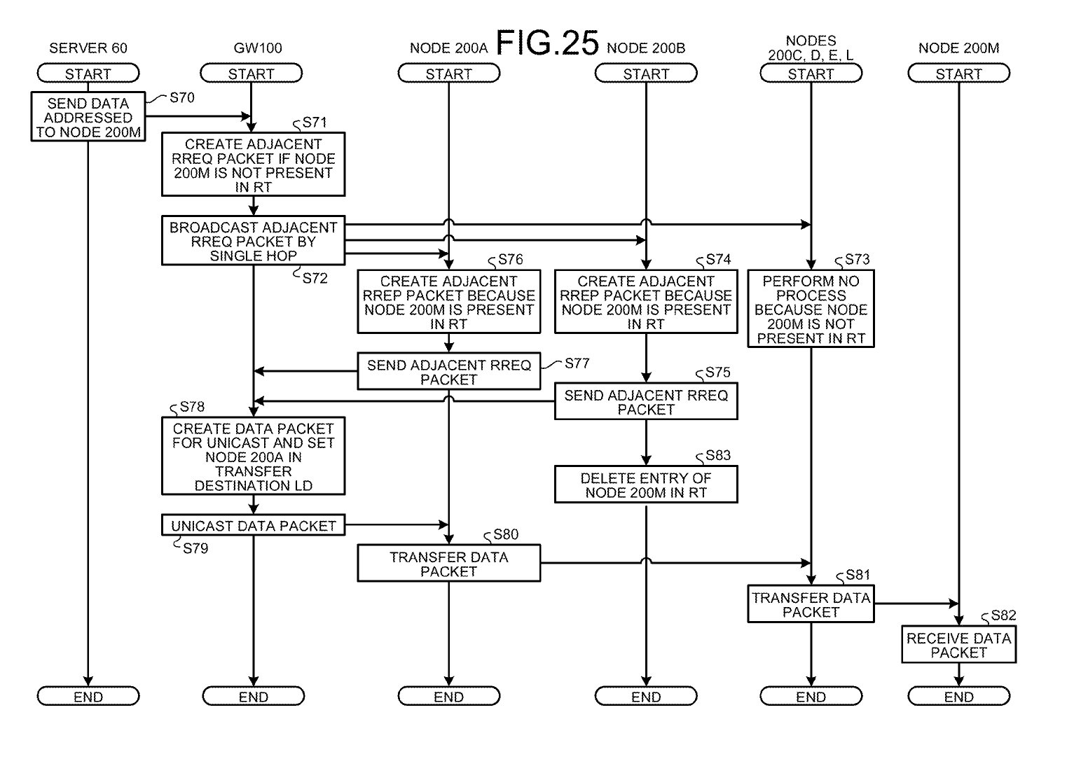

In the following, another embodiment will be described. FIG. 25 is a schematic diagram illustrating another embodiment. In the processing sequence described with reference to FIG. 7, the description has been given of a case in which the GW 100 receives an adjacent RREP packet from the node 200A. In FIG. 25, a description will be given of a case in which an adjacent RREP packet is received from each of the node 200A and the node 200B. In this case, for example, the GW 100 selects greater received signal strength indication between the adjacent RREP packets and unicasts a data packet to the selected send source node of the adjacent RREP packet.

Furthermore, it is assumed that the entry registration of the node 200M is not present in the RT in the GW 100 and it is assumed that the entry registration of the node 200M is present in the RT in each of the nodes 200A and 200B. Furthermore, it is assumed that the nodes 200A, 200B, 200C, 200D, and 200E are adjacent nodes of the GW 100.

As illustrated in FIG. 25, the server 60 sends the data that is to be addressed to the node 200M to the GW 100 (Step S70). If the node 200M is not present in the RT in the GW 100, the GW 100 creates an adjacent RREQ packet (Step S71). At Step S71, the GW 100 sets the address of the node 200M in the GD in the payload portion in the adjacent RREQ packet.

The GW 100 broadcasts the adjacent RREQ packet by a single hop (Step S72). Because of the single hop broadcast performed at Step S12, the adjacent RREQ packet is sent to the nodes 200A, 200B, 200C, 200D, 200E, and 200L that are adjacent to the GW 100.

Because the node 200M is not present in their own RT in the nodes 200C, 200D, 200E, and 200L, the nodes 200C, 200D, 200E, and 200L perform no process (Step S73). Because the node 200M is present in the RT in the node 200B, the node 200B creates an adjacent RREP packet (Step S74). The node 200B sends the adjacent RREP packet to the GW 100 (Step S75). At Step S75, after the node 200B has sent the adjacent RREP packet, the node 200B starts up a timer.

Because the node 200M is present in the RT in the node 200A, the node 200A creates an adjacent RREP packet (Step S76). The node 200A sends the adjacent RREP packet to the GW 100 (Step S77). At Step S77, after the node 200A has sent the adjacent RREP packet, the node 200A starts up a timer.

The GW 100 creates a data packet for unicast, sets the address of the node 200M in the GD in the data packet, and sets the address of the node 200A in the LD in the data packet (Step S78). At Step S78, the GW 100 compares the received signal strength indication of the adjacent RREP packet received from the node 200A with that of the adjacent RREP packet received from the node 200B. For example, if the received signal strength indication of the adjacent RREP packet received from the node 200A is greater than that received from the node 200B, the GW 100 sets the address of the node 200A in the LD.

The GW 100 unicasts the data packet to the node 200A (Step S79). The node 200A transfers the data packet received from the GW 100 to the node 200L (Step S80). At Step S80, the node 200A sets the address of the node 200M in the GD in the data packet and sets the address of the node 200L in the LD the data packet. Furthermore, the node 200A stops the started up timer.

The node 200L transfers the data packet transferred from the node 200A to the node 200M (Step S81). At Step S81, the node 200L sets the address of the node 200M in the GD in the data packet and sets the address of the node 200M in the LD in the data packet. Then, the node 200M receives the data packet via the nodes 200A and 200L (Step S82).

Furthermore, the node 200B ends the timer and becomes a time-out state. In this case, the node 200B deletes the entry of the node 200M from the RT in the node 200B (Step S83). Furthermore, instead of deleting the entry of the node 200M, if an entry in the RT needs to be updated, the node 200B may also set the entry that can be deleted with priority.

As described above, if the GW 100 receives adjacent RREP packets from multiple adjacent nodes, the GW 100 sets the send source node of the adjacent RREP packet with the maximum received signal strength indication to the transfer destination and sends the packet. Consequently, the GW 100 can send the packet to the destination by using a path having better communication quality.

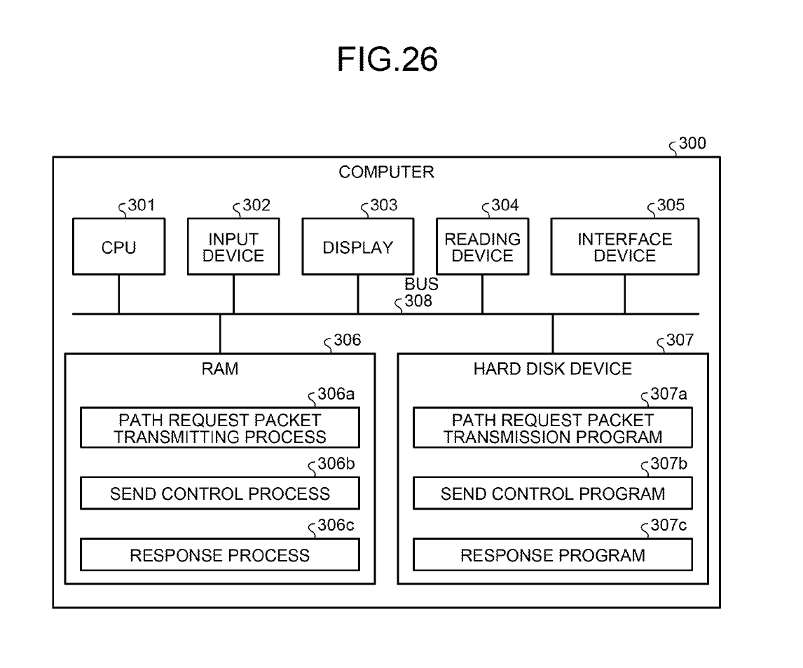

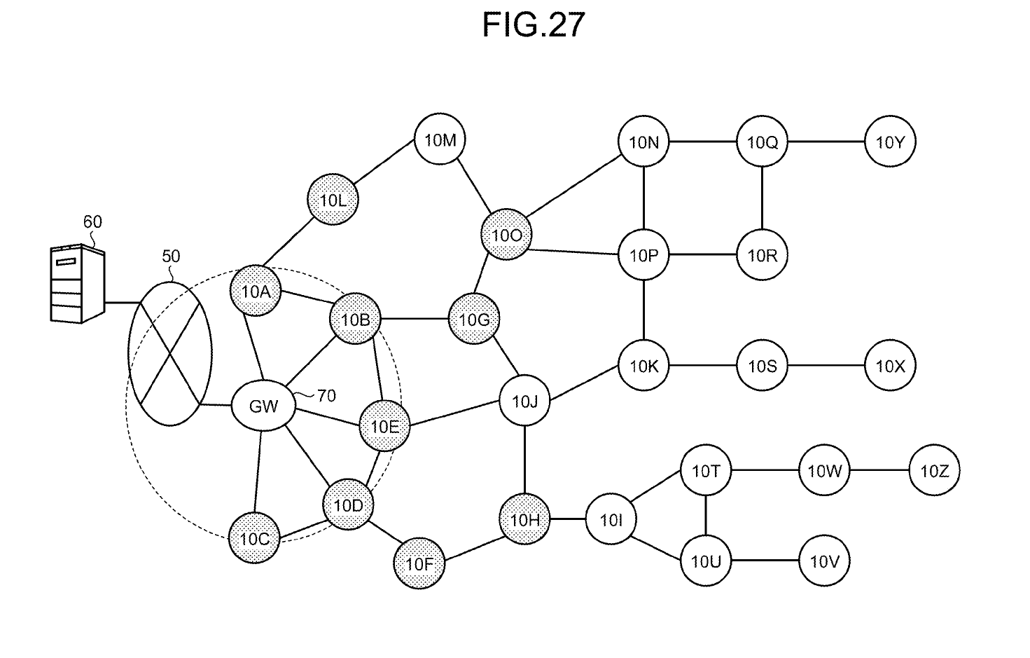

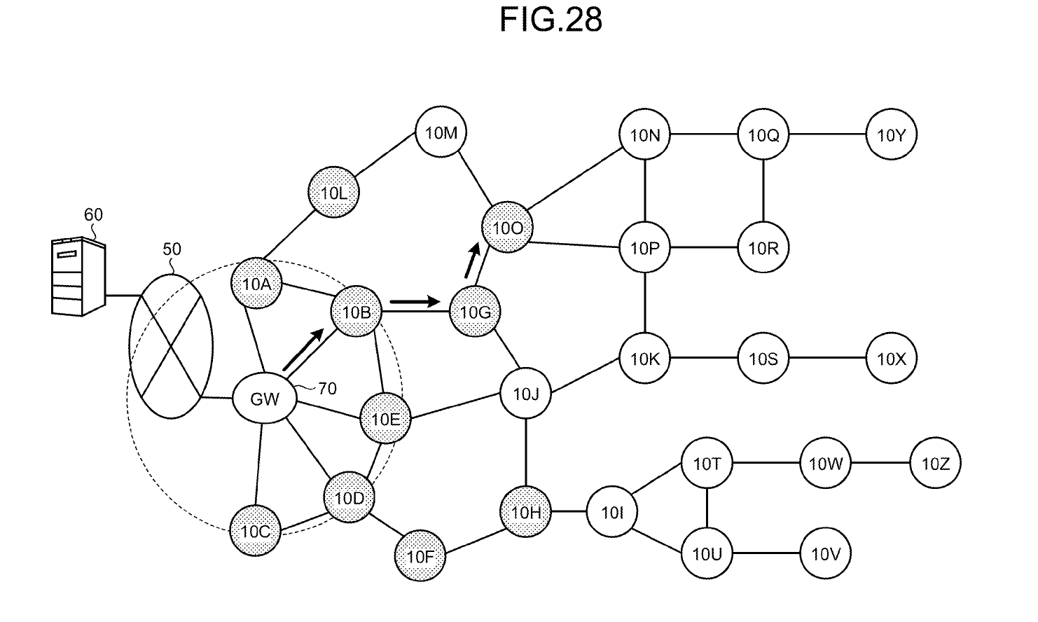

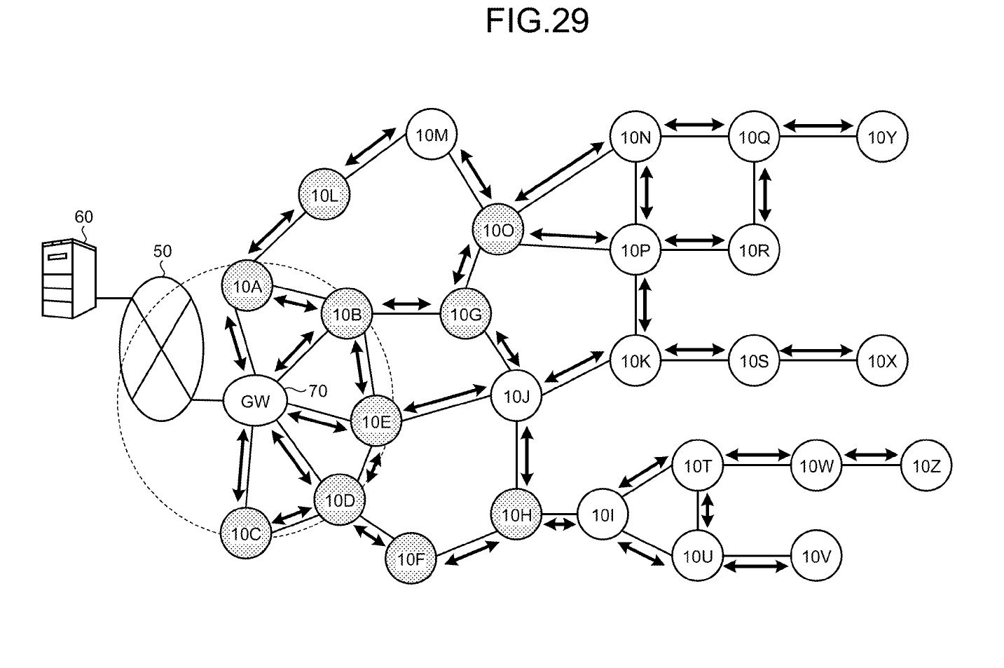

In the following, a description will be given of an example of a computer that executes a transmission program that implements the same function as that performed by the GW 100 or the nodes 200 described in the above embodiments. FIG. 26 is a block diagram illustrating an example of a computer that executes the transmission program.

As illustrated in FIG. 26, a computer 300 includes a CPU 301 that executes various kinds of arithmetic processing, an input device 302 that receives an input of data from a user, and a display 303. Furthermore, the computer 300 includes a reading device 304 that reads a program or the like from a storage medium and includes an interface device 305 that sends and receives data to and from another computer via a network. Furthermore, the computer 300 includes a RAM 306 and a hard disk device 307 each of which temporarily stores therein various kinds of information. Then, each of the devices 301 to 307 are connected to a bus 308.

The hard disk device 307 includes, for example, a path request packet transmission program 307a, a send control program 307b, and a response program 307c. The CPU 301 reads each of the programs 307a to 307c and loads the programs in the RAM 306.

The path request packet transmission program 307a functions as a path request packet transmitting process 306a. The send control program 307b functions as a send control process 306b. The response program 307c functions as a response process 306c.

For example, the path request packet transmitting process 306a corresponds to the path request packet sending unit 82, the adjacent packet processing unit 113, and the like. The send control process 306b corresponds to the send control unit 83, the adjacent packet processing unit 113, and the like. The response process 306c corresponds to the adjacent packet processing unit 113 and the like.

Furthermore, each of the programs 307a to 307c does not need to be stored in the hard disk device 307 in advance from the beginning. For example, each of the programs is stored in a “portable physical medium”, such as a flexible disk (FD), a CD-ROM, a DVD disk, a magneto-optic disk, an IC CARD, or the like that is to be inserted into the computer 300. Then, the computer 300 may also read and execute each of the programs 307a to 307c from the portable physical medium.

The adjacent packet processing unit 113 described in the second embodiment is an example of a path request packet sending unit, a send control unit, and a responding unit. The adjacent packet processing unit 113 may also be constructed by the path request packet sending unit, the send control unit, and the responding unit.

According to an aspect of an embodiment of the present invention, an advantage is provided in that the transmission rate of flooding can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network device comprising:
a memory; and
a processor coupled to the memory, wherein the processor executes a process comprising:
broadcasting a path request packet in which a destination information on a first packet is set, to adjacent nodes, when the destination information on the first packet is not present in a routing table that is stored in the memory and in which destination information on other nodes included in an ad hoc network is set;
sending a second packet by setting a send source node of a path response packet to the transfer destination of the second packet, when the path response packet associated with the path request packet is received from one of the other nodes; and
flooding a third packet in which the destination information on the first packet is set, when the path response packet is not received.

2. The network device according to claim 1, wherein the process further comprises receiving a path request packet from one of the other nodes included in the ad hoc network,
sending the path response packet to the node that is the send source of the path request packet, when the destination information that is set in the path request packet is present in the routing table, suspending a transmission of the path response packet, when the destination information that is set in the path request packet is not present in the routing table.

3. The network device according to claim 1, wherein, when path response packets are received from a plurality of adjacent nodes, the sending sends the second packet after setting a send source node of a path response packet with the maximum received signal strength indication to the transfer destination.

4. A non-transitory computer-readable recording medium having stored therein a transmission program causing a computer to execute a process comprising:
broadcasting a path request packet in which a destination information on a first packet is set, to adjacent nodes, when the destination information on the first packet is not present in a routing table that is stored in the memory and in which destination information on other nodes included in an ad hoc network is set;
sending a second packet by setting a send source node of a path response packet to the transfer destination of the second packet, when the path response packet associated with the path request packet is received from one of the other nodes; and
flooding a third packet in which the destination information on the first packet is set, when the path response packet is not received.
